(19) United States
(12) Patent Application Publication
(10) Pub. No.: US 2026/0243368 A1
(43) Pub. Date: Aug. 20, 2026

(54) FRICTIONLESS POSITION INDICATION TRANSFER MECHANISM FOR QUARTER-TURN ACTUATOR

(71) Applicant: Saudi Arabian Oil Company, Dhahran (SA)

(72) Inventor: Oscar Jose Lugo Duque, Ras Tanura (SA)

(73) Assignee: Saudi Arabian Oil Company, Dhahran (SA)

(21) Appl. No.: 19/056,931

(22) Filed: Feb. 19, 2025

(51) Int. Cl. F16K 37/00

(52) U.S. Cl. CPC F16K 37/0008

(57) ABSTRACT

A position indicator system includes a grooved scotch yoke comprising four mount slots machined into a top surface of the grooved scotch yoke and a cross drive bar comprising four cross arms. Each cross arm is installed within a corresponding mount slot in the grooved scotch yoke. The position indicator system also includes a hole formed through each pair of cross arms and mount slots. Each hole extends from a corresponding cross arm into a corresponding mount slot in the grooved scotch yoke. The position indicator system further includes a roll pin installed into each hole and fixedly connecting the cross drive bar to the grooved scotch yoke and a position indicator. The position indicator includes a position indicator flange having four vertical slots and an indicator arm jutting out from the position indicator. Each vertical slot is inserted over a corresponding cross arm on the cross drive bar.

### BACKGROUND

Valves are used to control the flow of fluids through conduits. The majority of a valve's operation occurs within a housing. As such, depending on the design of the valve and the valve's actuator, it can be difficult to determine the valve's current position from an external view of the valve. Thus, valves and/or their actuators include an indicator system that interacts with a visual position indicator, located external to the valve, such that a user can look at the position indicator to determine the valve's position. However, due to the frequency of actuation and fatigue, indicator systems often fail due to damage to their sub-components.

When indicator systems fail, a user may unintentionally open a closed valve or unintentionally close an open valve. In certain scenarios, this type of accident can be detrimental to the health and safety of people and/or the environment. For example, an uncontrolled release of hazardous substances may occur if a valve containing said substances is incorrectly actuated. As such, it is important that position indicator systems for valves are accurate and do not fail.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments methods and systems for indicating the position of a valve. In some embodiments, the position indicator system includes a grooved scotch yoke comprising four mount slots machined into a top surface of the grooved scotch yoke and a cross drive bar comprising four cross arms. Each cross arm is installed within a corresponding mount slot in the grooved scotch yoke. The position indicator system also includes a hole formed through each pair of cross arms and mount slots. Each hole extends from a corresponding cross arm into a corresponding mount slot in the grooved scotch yoke. The position indicator system further includes a roll pin installed into each hole and fixedly connecting the cross drive bar to the grooved scotch yoke and a position indicator. The position indicator includes a position indicator flange having four vertical slots and an indicator arm jutting out from the position indicator. Each vertical slot is inserted over a corresponding cross arm on the cross drive bar.

In some embodiments, a system includes a valve installed along a pipeline that is configured to move from a closed position to an open position, an actuator operatively coupled to the valve via a grooved scotch yoke, wherein the grooved scotch yoke comprises four mount slots machined into a top surface of the grooved scotch yoke, and a position indicator system operatively coupled to the actuator via the grooved scotch yoke. The position indicator system comprises a cross drive bar, holes, roll pins, and a position indicator. The cross drive bar comprises four cross arms. Each cross arm is installed within a corresponding mount slot in the grooved scotch yoke. Each hole is formed through each pair of cross arms and mount slots and each hole extends from a corresponding cross arm into a corresponding mount slot in the grooved scotch yoke. A roll pin is installed into each hole and fixedly connects the cross drive bar to the grooved scotch yoke. The position indicator includes a position indicator flange having four vertical slots, wherein each vertical slot is inserted over a corresponding cross arm on the cross drive bar, and an indicator arm jutting out from the position indicator, wherein the indicator arm is configured to indicate if the valve is in the open position or the closed position based on a rotation of the grooved scotch yoke.

In some embodiments, the position indication method includes installing a valve along a pipeline; controlling a flow of fluid through the pipeline by placing the valve in an open position or a closed position; operatively coupling an actuator to the valve using a grooved scotch yoke, wherein the grooved scotch yoke comprises four mount slots machined into a top surface of the grooved scotch yoke; and operatively coupling a position indicator system to the actuator via the grooved scotch yoke. The position indicator system comprises a cross drive bar comprising four cross arms, wherein each cross arm is installed within a corresponding mount slot in the grooved scotch yoke, a hole formed through each pair of cross arms and mount slots, wherein each hole extends from a corresponding cross arm into a corresponding mount slot in the grooved scotch yoke, a roll pin installed into each hole and fixedly connecting the cross drive bar to the grooved scotch yoke, and a position indicator. The position indicator includes a position indicator flange having four vertical slots, wherein each vertical slot is inserted over a corresponding cross arm on the cross drive bar, and an indicator arm jutting out from the position indicator. The method finally includes indicating whether the valve is in the open position or the closed position using the indicator arm, wherein the indicator arm indicates if the valve is in the open position or the closed position based on a rotation of the grooved scotch yoke.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an actuator connected to a valve positioned along a pipeline transporting a flow of fluid in accordance with one or more embodiments.

FIGS. 2a and 2b shows a cutaway view of the actuator in accordance with one or more embodiments.

FIG. 3 shows an exploded view of the position indicator system in accordance with one or more embodiments.

FIG. 4 shows a side view of the assembled position indicator system in accordance with one or more embodiments.

FIG. 5 shows a top-angled side view of the exploded position indicator system in accordance with one or more embodiments.

FIG. 6 shows a bottom view of the assembled position indicator system in accordance with one or more embodiments.

FIG. 7 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

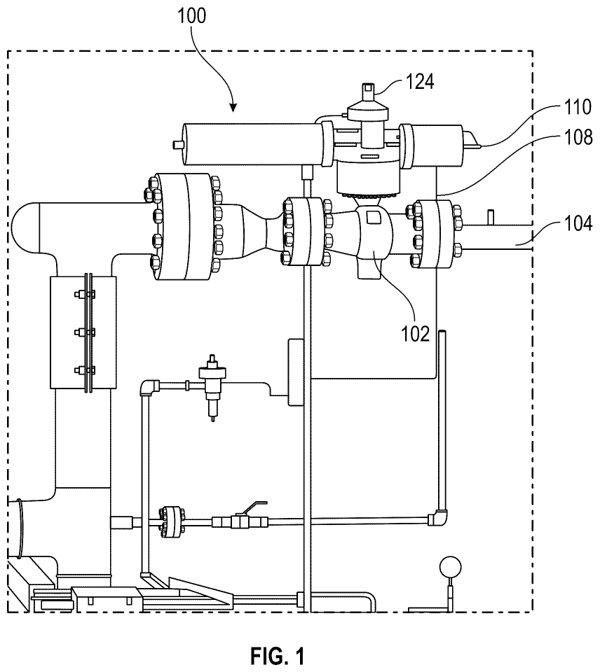

FIG. 1 shows an actuator (100) connected to a valve (102) positioned along a pipeline (104) transporting a flow of fluid in accordance with one or more embodiments. The valve (102) controls the flow of fluid through the pipeline (104) by opening or closing or moving to any position therebetween. The fluid may be any mixture or type of fluid known in the art, such as hydrocarbons, brine, chemical mixtures, etc. The valve (102) may be any type of valve known in the art, such as a ball valve, plug valve, butterfly valve, etc. The valve (102) is installed along the pipeline (104) using any means known in the art, such as a threaded connection, welded connection, bolted connection, etc.

The actuator (100) is operatively connected to the valve (102) such that the actuator (100) manipulates the position of the valve (102) (i.e., open, closed, or any position therebetween). In accordance with one or more embodiments, the actuator (100) is a quarter-turn actuator. A quarter-turn actuator is a device designed to control the operation of a valve (102) that requires a rotational movement of 90 degrees (a quarter turn) to open, close, or adjust its position.

In accordance with one or more embodiments, the actuator (100) is powered using a power fluid (106). The power fluid (106) may be any power fluid (106) known in the art such as hydraulic fluid, pneumatic fluid, etc. FIG. 1 shows power fluid lines (108) connected to the actuator (100). The power fluid lines (108) transport the power fluid (106) to the actuator (100) from a power fluid source (not pictured). The power fluid (106) is used to change the position of the valve (102). In accordance with one or more embodiments, the power fluid (106) enters the actuator (100) at a power fluid port (110) to open the valve (102). In further embodiments, the power fluid (106) is removed from the actuator (100) via the power fluid port (110) and the power fluid lines (108) to close the valve (102).

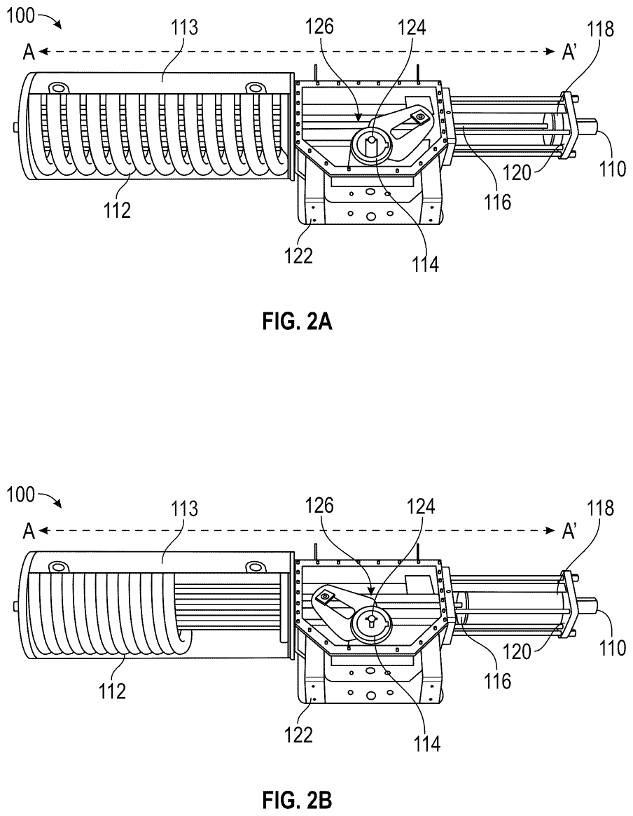

FIGS. 2a and 2b shows a cutaway view of the actuator (100) in accordance with one or more embodiments. FIG. 2a shows the actuator (100) in a first position. FIG. 2b shows the actuator (100) in a second position. Components shown in FIGS. 2a and 2b that are the same as or similar to components shown in FIG. 1 have not been redescribed for purposes of readability and have the same description and function as outlined above.

The actuator (100) operates to manipulate the valve (102) using a spring (112), a grooved scotch yoke (114), a piston (116), a piston head (118), and a fluid chamber (120)—all of which are encapsulated in a housing (122). FIG. 2a shows the spring (112) in a relaxed/uncompressed state and little to no power fluid (106) in the fluid chamber (120). FIG. 2b shows the spring (112) in a compressed state with power fluid (106) located in the fluid chamber (120).

The piston (116) is configured to move along axis A-A′ and is operatively connected to the grooved scotch yoke (114) and the spring (112). The spring (112) is housed in a spring housing (113). The spring (112), in its relaxed position, holds the actuator (100) in the first position (shown in FIG. 2A). As the piston (116) moves along the A-A′ axis, the piston (116) compresses the spring (112) and places the actuator (100) in the second position (shown in FIG. 2A).

Specifically, as the piston (116) moves along the A-A′ axis from the first position to the second position, the spring (112) compresses and the piston (116) rotates the grooved scotch yoke (114) a quarter of a turn (i.e., 90-degrees). The grooved scotch yoke (114) is operatively connected to the valve (102). Thus, as the grooved scotch yoke (114) rotates, the internal components of the valve (102) are correspondingly manipulated from one position to another.

The piston (116) is translated along the A-A′ axis by pumping the power fluid (106) into the fluid chamber (120) via the power fluid port (110) and the power fluid lines (108). The fluid chamber (120) is delineated by the inner surface of the housing (122) and between the piston head (118) and the power fluid port (110). The piston head (118) is shaped and manufactured such that it creates a seal between the inner surface of the housing (122) and itself. Due to this seal, power fluid (106) may be pumped into the fluid chamber (120) and, instead of leaking past the piston head (118), the power fluid (106) applies a force against the piston head (118) and pushes the piston (116) along the A-A′ axis to compress the spring (112) and place the actuator (100) in the second position (shown in FIG. 2b).

In accordance with one or more embodiments, the valve (102) operatively connected to the actuator (100) is an emergency isolation valve (102). An emergency isolation valve (102) is designed to close quickly and stop the flow of fluids in emergency situations. Thus, emergency isolation valves (102) may be designed to fail safe to a closed position.

As such, the first position of the actuator (100) (shown in FIG. 2a) may correspond with the valve (102) being in a closed position. This is because the spring (112) will naturally revert to this position if there is an issue with the power fluid (106) supply. In other words, if the first position of the actuator (100) is associated with the valve (102) being in a closed position, the actuator (100) and the valve (102) would not rely on power fluid (106) to stop a flow of fluids through the pipeline (104). Instead, the actuator (100) and the valve (102) require the power fluid (106) to place the actuator (100) in the second position and open the valve (102). Therefore, if there is a failure, the fail-safe is a closed position, thus preventing the flow of fluids through the pipeline (104).

Accordingly, to open the valve (102), a power fluid (106) is pumped from a power fluid source, through the power fluid lines (108), through the power fluid port (110), and into the fluid chamber (120) of the actuator (100). The power fluid (106) applies force to the piston head (118) to translate the piston (116) along the A-A′ axis. As the piston (116) moves along the A-A′ axis, the piston (116) compresses the spring (112) and rotates the grooved scotch yoke (114) which, in turn, rotates the internal components of the valve (102) to allow passage of fluid through the valve (102).

To close the valve (102), the power fluid (106) is removed from the fluid chamber (120), via the power fluid port (110) and the power fluid lines (108). As the power fluid (106) is removed, the spring (112) decompresses, and the piston (116) is translated along the A-A′ axis in an opposite direction from the direction is translated along to open the valve (102). As the piston (116) moves along the A-A′ axis, the piston (116) rotates the grooved scotch yoke (114) which, in turn, rotates the internal components of the valve (102) to prevent passage of fluid through the valve (102).

In accordance with one or more embodiments, the valve (102) may be manually actuated either by the use of a handwheel (not pictured) connected to the spring (112) or by a manual injection of power fluid into the power fluid chamber (120) via the power fluid port (110).

As outlined above, it is important to know what position the actuator (100) and the valve (102) is in currently. As is clear from FIG. 1 (showing an external view of the actuator (100) and the valve (102)), it is difficult to visually determine what position the actuator (100) and the valve (102) are, in because the components that move positions are all located within housings. As such, a position indicator (124) is used to visually display the position the valve (102).

The position indicator (124) is part of a position indicator system (126), the majority of which is located within the housing (122) of the actuator (100). As outlined above, it is important that the position indicator system (126) does not fail so that operators can confidently know and manipulate the position of the actuator (100) and the valve (102). However, the position actuator systems currently available often fail due to the internal static position indication signal's inability to transition between indication states, even when the valves are manually operated. In particular, the sub-components of the internal position indicator system are often damaged, which leads to the inability of the internal static position indication signal to transition between indication states.

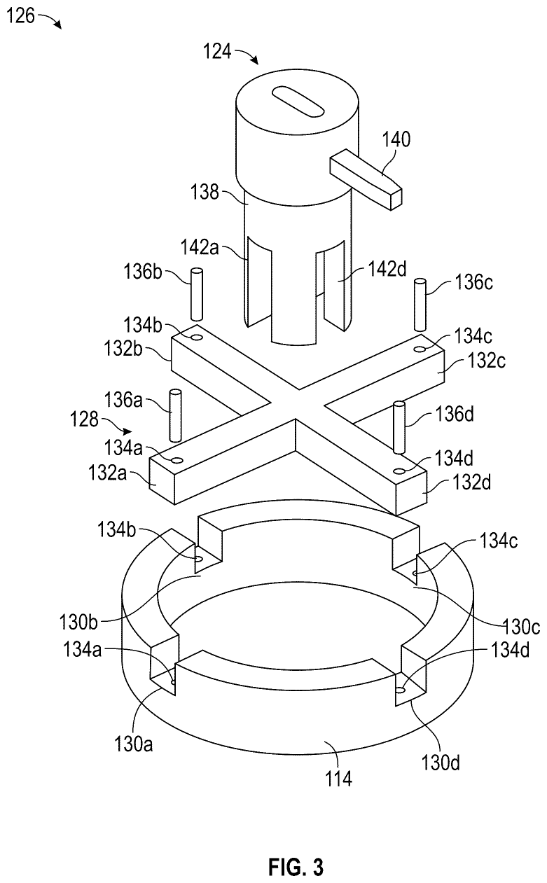

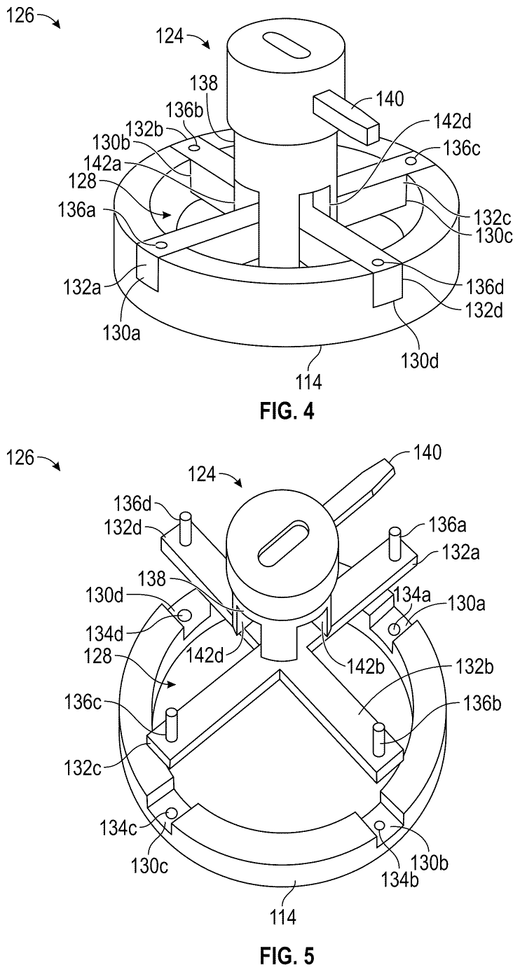

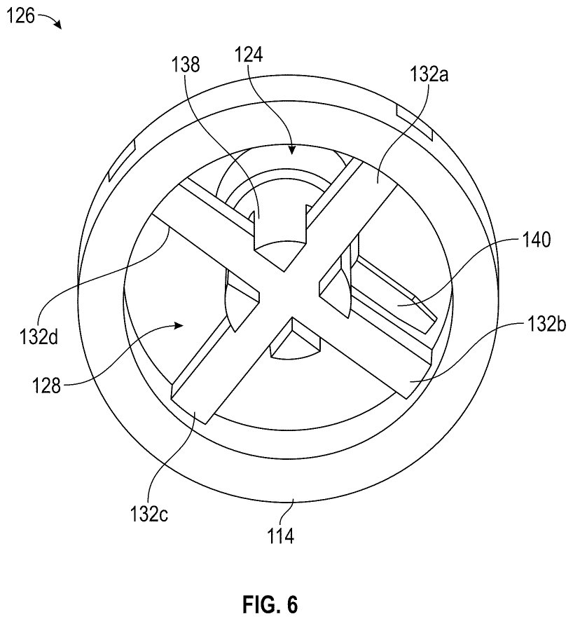

As such, FIGS. 3-6 show a position indicator system (126) that is specifically designed to prevent damage to the sub-components of the position indicator system (126) and increase accuracy of the position indicator (124). FIG. 3 shows an exploded view of the position indicator system (126) in accordance with one or more embodiments. FIG. 4 shows a side view of the assembled position indicator system (126) in accordance with one or more embodiments. FIG. 5 shows a top-angled side view of the exploded position indicator system (126) in accordance with one or more embodiments. FIG. 6 shows a bottom view of the assembled position indicator system (126) in accordance with one or more embodiments.

The position indicator system (126) includes the position indicator (124), a cross drive bar (128), and the grooved scotch yoke (114). These components may be made of steel or another alloy material. The grooved scotch yoke (114) is a cylindrical ring with four mount slots (first mount slot (130a), second mount slot (130b), third mount slot (130c), fourth mount slot (130d)) machined into the top surface of the grooved scotch yoke (114). The mount slots (130a-d) are formed symmetrically along the top surface of the grooved scotch yoke (114). That is, the mount slots (130a-d) are equ-distant from each other along the top surface of the grooved scotch yoke (114).

The cross drive bar (128) is formed in an equal-armed cross. That is, the cross drive bar (128) has a four cross arms (first cross arm (132a), second cross arm (132b), third cross arm (132c), fourth cross arm (132d)) and each cross arm (132a-d) has the same length and dimensions. In accordance with one or more embodiments, the cross arms (132a-d) are rectangular prisms. The geometric shape of each mount slot (130a-d) corresponds with the geometric shape of the corresponding cross arm (132a-d) such that the cross arm (132a-d) can sit flush within its corresponding mount slot (130a-d).

A hole is drilled though the bottom of each mount slot (130a-d). In accordance with one or more embodiments, the hole is drilled only partially through the bottom of each mount slot (130a-d) so that it does not extend to the opposite side of the mount slot (130a-d). A hole is also drilled through each cross drive bar (128) such that the hole of the mount slot (130a-d) lines up with the hole of the corresponding cross arm (132a-d) to form one continuous hole (first hole (134a), second hole (134b), third hole (134c), fourth hole (134d)). The hole (134a-d) extends completely through the cross drive bar (128) and partially through the corresponding mount slot (130a-d).

A roll pin (first roll pin (136a), second roll pin (136b), third roll pin (136c), fourth roll pin (136d)) is configured to be inserted into a corresponding hole (134a-d) to fix the cross arms (132a-d) to the mount slots (130a-d). The roll pin (136a-d) may also be known as a spring pin or tension pin and is a mechanical fastener designed to secure the position of two or more parts relative to each other. In accordance with one or more embodiments, the roll pin (136a-d) is a cylindrical pin made of a durable material, e.g., a steel alloy, and is slightly larger in diameter than the hole (134a-d) into which it is intended to fit.

The position indicator (124) has a position indicator flange (138) and an indicator arm (140). The position indicator flange (138) is formed in a cylindrical-like shape and comprises four vertical slots (first vertical slot (142a), second vertical slot (142b), third vertical slot (142c), fourth vertical slot (142d)) machined into the bottom surface of the position indicator flange (138). The shape of each vertical slot (142a-d) corresponds with the shape of the corresponding cross arm (132a-d) such that the vertical slot (142a-d) can sit flush over its corresponding cross arm (132a-d).

Accordingly, a distal end of the first cross arm (132a) is installed in the first mount slot (130a) of the grooved scotch yoke (114). A first hole (134a) extends from the first cross arm (132a) into the first mount slot (130a). A first roll pin (136a) is inserted into the first hole (134a) to fixedly connect the first cross arm (132a) to the first mount slot (130a). The first vertical slot (142a) is inserted on top of the first cross arm (132a), closer to the center of the cross drive bar (128) when compared to the location where the first mount slot (130a) connects to the first cross arm (132a).

Similarly, a distal end of the second cross arm (132b) is installed in the second mount slot (130b) of the grooved scotch yoke (114). A second hole (134b) extends from the second cross arm (132b) into the second mount slot (130b). A second roll pin (136b) is inserted into the second hole (134b) to fixedly connect the second cross arm (132b) to the second mount slot (130b). The second vertical slot (142b) is inserted on top of the second cross arm (132b), closer to the center of the cross drive bar (128) when compared to the location where the second mount slot (130b) connects to the second cross arm (132b).

Similarly, a distal end of the third cross arm (132c) is installed in the third mount slot (130c) of the grooved scotch yoke (114). A third hole (134c) extends from the third cross arm (132c) into the third mount slot (130c). A third roll pin (136c) is inserted into the third hole (134c) to fixedly connect the third cross arm (132c) to the third mount slot (130c). The third vertical slot (142c) is inserted on top of the third cross arm (132c), closer to the center of the cross drive bar (128) when compared to the location where the third mount slot (130c) connects to the third cross arm (132c).

Similarly, a distal end of the fourth cross arm (132d) is installed in the fourth mount slot (130d) of the grooved scotch yoke (114). A fourth hole (134d) extends from the fourth cross arm (132d) into the fourth mount slot (130d). A fourth roll pin (136d) is inserted into the fourth hole (134d) to fixedly connect the fourth cross arm (132d) to the fourth mount slot (130d). The fourth vertical slot (142d) is inserted on top of the fourth cross arm (132d), closer to the center of the cross drive bar (128) when compared to the location where the fourth mount slot (130d) connects to the fourth cross arm (132d).

Due to this design, the position indicator (124) is fixedly connected to the grooved scotch yoke (114). That is, the position indicator (124) is unable to rotate unless the grooved scotch yoke (114) rotates. The position indicator (124) includes an indicator arm (140) which juts out from the position indicator (124). If the grooved scotch yoke (114) rotates, then the position indicator (124) must also rotate, moving the direction of the indicator arm (140). The indicator arm (140) may be used by an operator to determine what position the actuator (100) and the valve (102) is in due to the change in direction of the indicator arm (140). As such, the portion of the position indicator (124) having the indicator arm (140) juts out from the housing (122) such that an operator can see the indicator arm (140) when looking at the actuator (100) externally. In other embodiments, the indicator arm (140) may be a switch. When the indicator arm (140) is a switch, its movement triggers an electronic panel to display a pre-coded message, such as “open” or “closed.”

The disclosed position indicator system (126) avoids future failures by creating a safe clearance between the cross-key design of the position indicator flange (138) and the cross drive bar (128) which is embedded in the four mount slots (130a-d) machined into the top surface of the grooved scotch yoke (114). The disclosed position indicator system's (126) design also avoids failures by eliminating weak points such as at the roll pins (136a-d) inserted into the top surface of the grooved scotch yoke (114) and along the contact surface between the top of the cross drive bar (128) and the bottom surface of the position indicator flange (138) of the position indicator (124). Overall, the disclosed position indicator system (126) incorporates and provides stronger pivoting points compared to the pivoting points of currently available systems.

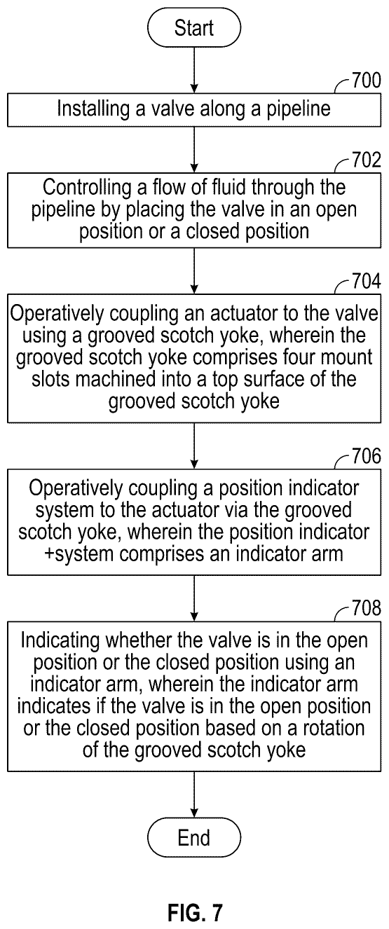

FIG. 7 shows a flowchart in accordance with one or more embodiments. The flowchart outlines a method for visually indication the position of a valve. While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In S700, a valve (102) is installed along a pipeline (104). The valve (102) may be any type of valve known in the art (e.g., butterfly, ball, plug, etc.) and the pipeline (104) may be transporting any fluid known in the art (e.g., hydrocarbons, brine, other chemical mixtures, etc.). The valve (102) may also be installed along the pipeline (104) using any means known in the art (e.g., threaded, welded, bolted, etc.). The valve (102) and pipeline (104) may be made out of any material known in the art (e.g., a steel alloy).

In S702, a flow of fluid is controlled through the pipeline (104) by placing the valve (102) in an open position or a closed position. In accordance with one or more embodiments, placing the valve (102) in an open position allows the flow of fluid through the pipeline (104) and placing the valve (102) in the closed position prevents the flow of fluid through the pipeline (104).

In S704, an actuator (100) is operatively coupled to the valve (102) using a grooved scotch yoke (114). The grooved scotch yoke (114) comprises four mount slots (130a-d) machined into a top surface of the grooved scotch yoke (114). The actuator (100) may be a quarter-turn actuator configured to actuate (i.e., place in the open position or the closed position) the valve (102).

In S705, a position indicator system (126) is operatively coupled to the actuator (100) via the grooved scotch yoke (114). The position indicator system (126) comprises a cross drive bar (128) having four cross arms (132a-d). Each cross arm (132a-d) is installed within a corresponding mount slot (130a-d) in the grooved scotch yoke (114). A hole (134a-d) is formed through each pair of cross arms (132a-d) and mount slots (130a-d). Each hole (134a-d) extends from a corresponding cross arm (132a-d) into a corresponding mount slot (130a-d) in the grooved scotch yoke (114). A roll pin (136a-d) is installed into each hole (134a-d) and fixedly connects the cross drive bar (128) to the grooved scotch yoke (114).

The position indicator system (126) further includes a position indicator (124) made of a position indicator flange (138) and an indicator arm (140). The position indicator flange (138) has four vertical slots (142a-d). Each vertical slot (142a-d) is inserted over a corresponding cross arm (132a-d) on the cross drive bar (128). The indicator arm (140) juts out from the position indicator (124).

In accordance with one or more embodiments, the majority of the position indicator system (126) is located inside a housing (122) of the actuator (100) and only the portion of the position indicator (124) having the indicator arm (140) juts outside of the housing (122) so that an operator can visually see the indicator arm (140).

In S708, the indicator arm (140) indicates whether the valve (102) is in the open position, or the closed position based on a rotation of the grooved scotch yoke (114). In accordance with one or more embodiments, the grooved scotch yoke (114) rotates within the actuator (100) and as the grooved scotch yoke (114) rotates, it moves the position of the valve (102).

Due to the position indicator system's (126) integrated installation with the grooved scotch yoke (114), rotation of the grooved scotch yoke (114) also causes the rest of the position indicator system (126) to rotate. Because the indicator arm (140) juts out in only one direction from the position indicator (124), rotation of the position indicator system (126) causes the indicator arm (140) to move from pointing in one direction to another. This allows for an operator looking at the actuator (100) to determine that the indicator arm (140) has moved, meaning the valve (102) has also moved positions. In other embodiments, the indicator arm (140) may be a switch. When the indicator arm (140) is a switch, its movement triggers an electronic panel to display a pre-coded message, such as “open” or “closed.”

In accordance with one or more embodiments, the valve (102) is placed in the open position by pumping a power fluid (106) into the actuator (100). In such embodiments, power fluid lines (108) are connected to a power fluid port (110) on the actuator (100). The power fluid lines (108) transport a power fluid (106) to the power fluid port (110). The power fluid (106) enters a fluid chamber (120) and applies a force against the piston head (118). This force causes the piston head to push the piston (116), to which it is connected, along an axis.

In particular, the piston (116) is translated along the axis A-A′ in a direction towards a spring (112). As the piston (116) moves towards the spring (112), it compresses the spring (112) and rotates the grooved scotch yoke (114). As outlined above, rotation of the grooved scotch yoke (114) causes the valve (102) to move to an open position and causes the position indicator (124) to indicate that the valve (102) is in the open position. As long as the power fluid (106) remains in the fluid chamber (120), the force of the power fluid (106) against the piston head (118) should be strong enough to overcome the force of the spring (112)—keeping the valve (102) in the open position.

In accordance with one or more embodiments, the valve (102) is placed in the closed position by removing the power fluid (106) from the actuator (100). In such embodiments, the power fluid lines (108) remove the power fluid (106) from the fluid chamber of the actuator (100) via the power fluid port (110).

As the power fluid (106) is removed from the fluid chamber (120), the force of the spring (112) pushes the piston (116) translates the piston (116) along the A-A′ axis in a direction away from the spring (112). As the piston (116) moves in the direction away from the spring (112), the grooved scotch yoke (114) rotates. As outlined above, rotation of the grooved scotch yoke (114) causes the valve (102) to move to a closed position and causes the position indicator (124) to indicate that the valve (102) is in the closed position.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A position indicator system comprising:
a grooved scotch yoke comprising four mount slots machined into a top surface of the grooved scotch yoke;
a cross drive bar comprising four cross arms, wherein each cross arm is installed within a corresponding mount slot in the grooved scotch yoke;
a hole formed through each pair of cross arms and mount slots, wherein each hole extends from a corresponding cross arm into a corresponding mount slot in the grooved scotch yoke;
a roll pin installed into each hole and fixedly connecting the cross drive bar to the grooved scotch yoke; and
a position indicator comprising:
a position indicator flange having four vertical slots, wherein each vertical slot is inserted over a corresponding cross arm on the cross drive bar, and
an indicator arm jutting out from the position indicator.

2. The position indicator system of claim 1, wherein the grooved scotch yoke is configured to rotate.

3. The position indicator system of claim 2, wherein the indicator arm is configured to rotate in response to rotation of the grooved scotch yoke.

4. The position indicator system of claim 1, wherein the roll pin comprises a larger diameter than a diameter of the hole.

5. A system comprising:
a valve installed along a pipeline and configured to move from a closed position to an open position;
an actuator operatively coupled to the valve via a grooved scotch yoke, wherein the grooved scotch yoke comprises four mount slots machined into a top surface of the grooved scotch yoke; and
a position indicator system operatively coupled to the actuator via the grooved scotch yoke, the position indicator system comprising:
a cross drive bar comprising four cross arms, wherein each cross arm is installed within a corresponding mount slot in the grooved scotch yoke,
a hole formed through each pair of cross arms and mount slots, wherein each hole extends from a corresponding cross arm into a corresponding mount slot in the grooved scotch yoke,
a roll pin installed into each hole and fixedly connecting the cross drive bar to the grooved scotch yoke, and
a position indicator comprising:
a position indicator flange having four vertical slots, wherein each vertical slot is inserted over a corresponding cross arm on the cross drive bar, and
an indicator arm jutting out from the position indicator, wherein the indicator arm is configured to indicate if the valve is in the open position or the closed position based on a rotation of the grooved scotch yoke.

6. The system of claim 5, wherein the actuator further comprises a piston having a piston head and configured to be translated along an axis.

7. The system of claim 6, wherein the actuator further comprises a fluid chamber configured to be filled with a power fluid, wherein the power fluid is configured to apply a force against the piston head to translate the piston along the axis when the power fluid fills the fluid chamber.

8. The system of claim 7, wherein the grooved scotch yoke is operatively coupled to the valve and the piston, the piston is configured to rotate the grooved scotch yoke when the piston translates along the axis, and the rotation of the grooved scotch yoke causes the valve to move from the closed position to the open position.

9. The system of claim 8, wherein the actuator further comprises a spring having a relaxed state and a compressed state.

10. The system of claim 9, wherein the spring in the relaxed state places the actuator in a first position which is associated with the valve being in the closed position.

11. The system of claim 10, wherein the spring is placed in the compressed state when the power fluid applies the force to the piston head to translate the piston along the axis in a direction towards a spring.

12. The system of claim 11, wherein the spring in the compressed state places the actuator in a second position which is associated with the valve being in the open position.

13. A method comprising:
installing a valve along a pipeline;
controlling a flow of fluid through the pipeline by placing the valve in an open position or a closed position;
operatively coupling an actuator to the valve using a grooved scotch yoke, wherein the grooved scotch yoke comprises four mount slots machined into a top surface of the grooved scotch yoke;
operatively coupling a position indicator system to the actuator via the grooved scotch yoke, wherein the position indicator system comprises:
a cross drive bar comprising four cross arms, wherein each cross arm is installed within a corresponding mount slot in the grooved scotch yoke,
a hole formed through each pair of cross arms and mount slots, wherein each hole extends from a corresponding cross arm into a corresponding mount slot in the grooved scotch yoke,
a roll pin installed into each hole and fixedly connecting the cross drive bar to the grooved scotch yoke, and
a position indicator comprising:
a position indicator flange having four vertical slots, wherein each vertical slot is inserted over a corresponding cross arm on the cross drive bar, and
an indicator arm jutting out from the position indicator; and
indicating whether the valve is in the open position or the closed position using the indicator arm, wherein the indicator arm indicates if the valve is in the open position or the closed position based on a rotation of the grooved scotch yoke.

14. The method of claim 13, further comprising placing the valve in the open position using the grooved scotch yoke of the actuator.

15. The method of claim 14, wherein placing the valve in the open position further comprises pumping a power fluid into a fluid chamber of the actuator.

16. The method of claim 15, wherein placing the valve in the open position further comprises applying a force against a piston head connected to a piston using the power fluid to translate the piston along an axis in a direction towards a spring thereby compressing the spring.

17. The method of claim 16, wherein placing the valve in the open position further comprises translating the piston along the axis in the direction towards the spring to rotate the grooved scotch yoke and place the valve in the open position.

18. The method of claim 17, further comprising placing the valve in the closed position using the grooved scotch yoke of the actuator.

19. The method of claim 18, wherein placing the valve in the closed position further comprises removing the power fluid from the fluid chamber of the actuator thereby allowing the spring to relax and translate the piston along the axis in a direction away from the spring.

20. The method of claim 19, wherein placing the valve in the closed position further comprises translating the piston along the axis in the direction away from the spring to rotate the grooved scotch yoke and place the valve in the closed position.
